(19) United States
(12) Patent Application Publication
(10) Pub. No.: US 2010/0067662 A1
(43) Pub. Date: Mar. 18, 2010

(54) SWITCHING SCHEME FOR A STEREO ROTATING ANODE TUBE

(75) Inventors: Rainer Pietig, Herzogenrath (DE); Bernd David, Huettblek (DE); Astrid Lewalter, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/513,371

(22) PCT Filed: Oct. 24, 2007
(86) PCT No.: PCT/IB2007/054318

§ 371 Date: May 4, 2009

(30) Foreign Application Priority Data
Nov. 3, 2006 (EP) 06123447.2

(51) Int. Cl. H01J 35/10; H01J 35/26

(52) U.S. Cl. 378/124; 378/144

(57) ABSTRACT

For x-ray tubes the focal spot temperature is a critical factor. According to an exemplary embodiment of the present invention, an examination apparatus is provided which has a synchronisation unit providing an operation mode for a stereo tube in which the anode rotation frequency is synchronised with the switching frequency such that the switching frequency is a half integer multiple of the anode rotation frequency. This may lead to a significant reduction of the focal spot temperature.

The invention relates to the field of tomographic imaging. In particular, the invention relates to an examination apparatus for examination of an object of interest, a synchronization unit for an examination apparatus, to a method of examination of an object of interest, a computer-readable medium and a program element.

Conventional cone-beam computed tomography scanners may be provided with a stereo x-ray tube. Such a tube may considerably enlarge the field of view and may enable a significant reduction of cone-beam artefacts in axial cone-beam computed tomography. The enlarged field of view realizes a good utilization of the detector area, which is one of the main cost driver of a computed tomography (CT) scanner. Even more important, however, is the possibility to reduce cone-beam artefacts in circular scans, e.g. for cardiac CT. The whole heart may then be reconstructed from a circular scan.

A stereo tube has to be operated in a switching mode, i.e. only one focus emits x-rays at one time and fast switching between the two foci from view to view is done. Clearly, the average power dissipated within one anode is only half of the total power which may have the effect, that the temperature increase in both of the two anodes is less compared to temperature increase of the normal case of a single anode.

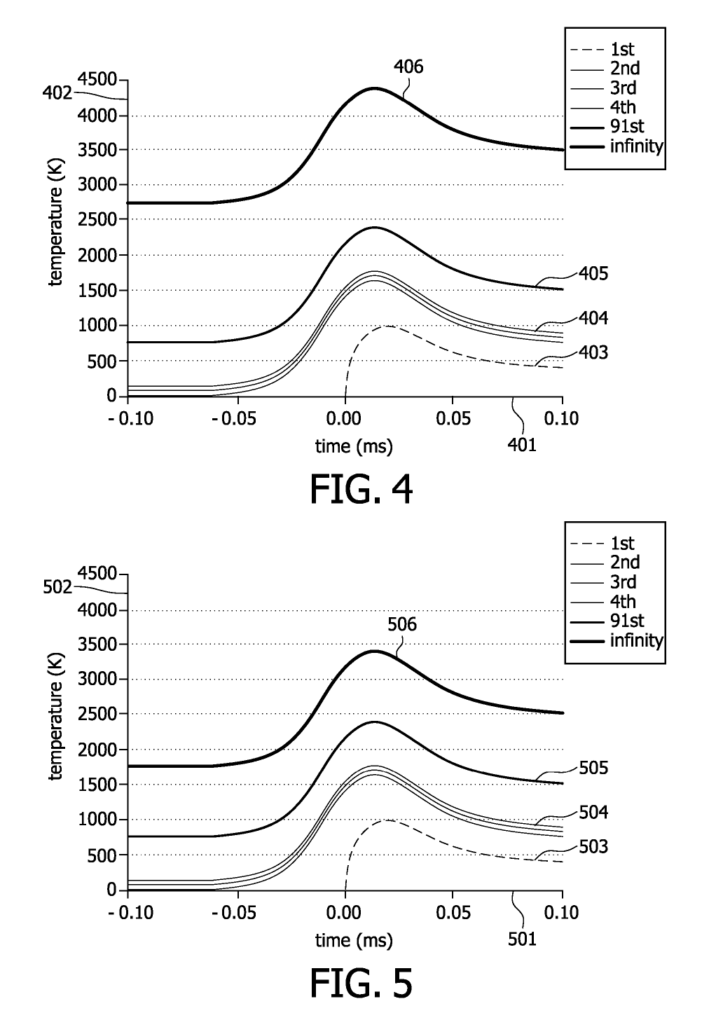

However, this effect may only become apparent at long time scales (i.e. much longer than the total scan time), since at the beginning of the scan, the maximum focal spot temperature is dominated by the short time temperature increase that each point in the focal track experiences while passing the electron beam. This is shown in FIG. 4 for the case of a single anode (just one focus, no switching).

It would be desirable to provide for an improved operation mode for an x-ray stereo tube, where the fact that each anode has to dissipate on average only half of the total power results in lower anode temperatures already during the scan.

Such an operation mode may thus allow to increase the peak power compared to a single anode tube.

According to an exemplary embodiment of the present invention, an examination apparatus for examination of an object of interest is provided, the examination apparatus comprising a source having a first anode and a second anode adapted for generating electromagnetic radiation and a synchronisation unit, wherein the first and second anodes are adapted as rotating anodes which rotate with an anode rotation frequency, wherein generation of the electromagnetic radiation is switched between the first and second anode with a switching frequency, wherein the synchronisation unit is adapted for synchronising the anode rotation frequency with the switching frequency, the synchronisation (s) corresponds to t_anode/t_switch=m*n−1, wherein t_anode is 1/(anode frequency), t_switch is the time an electron beam stays on the first anode before being switched to another anode (or vice versa), n is the number of anodes and m is an integer value, for example m=1; 2; 3; 4; . . . .

Therefore, an examination apparatus may be provided, which has rotating anodes with a synchronised rotation frequency. This may provide for an improved illumination scheme for an x-ray tube with multiple anodes in general.

According to another exemplary embodiment of the present invention, the source is adapted as a stereo rotating anode x-ray tube.

In other words, the source comprises two anode disks and two cathodes.

According to another exemplary embodiment of the present invention, the synchronisation unit is adapted for synchronising the anode rotation frequency with the switching frequency, such that the switching frequency is a half integer multiple of the anode rotation frequency.

Therefore, the rotation frequency (f_anode) of the anode is synchronized with the switching frequency (f_switching) in a special way, namely that the switching frequency is a half integer multiple of the anode rotation frequency, for example s=f_switching/f_anode=2,5; 3,5; 4,5; 5,5; . . . . This may maximize the time interval between two succeeding illuminations by the electron beam for each point within the two focal tracks.

According to another exemplary embodiment of the present invention, the examination apparatus is configured as one of the group consisting of a computered tomography apparatus and a coherent scatter computed tomography apparatus.

According to another exemplary embodiment of the present invention, the examination apparatus further comprises a collimator arranged between the electromagnetic radiation source and a detector unit, wherein the collimator is adapted for collimating an electromagnetic radiation beam emitted by the electromagnetic radiation source to form an axial cone-beam or a fan-beam.

Furthermore, according to another exemplary embodiment of the present invention, the examination apparatus is configured as one of the group consisting of a material testing apparatus, a medical application apparatus and a micro CT system.

A field of application of the invention may be medical imaging, in particular cardiac imaging.

According to another exemplary embodiment of the present invention, a synchronisation unit for an examination apparatus is provided, wherein the synchronisation unit is adapted for being connected to a source having a first anode and a second anode for generating electromagnetic radiation, wherein the first and second anodes are adapted as rotating anodes which rotate with an anode rotation frequency, wherein generation of the electromagnetic radiation is switched between the first and second anode with a switching frequency, and wherein the synchronisation unit is adapted for synchronising the anode rotation frequency with the switching frequency, such that the switching frequency is a half integer multiple of the anode rotation frequency.

This may provide for a synchronisation unit, which can be provided as a single module for reequipping present examination apparatuses in order to provide for an improved operation mode.

According to another exemplary embodiment of the present invention, the synchronisation unit is adapted for synchronising a stereo x-ray tube.

According to another exemplary embodiment of the present invention, a method of examination of an object of interest with an examination apparatus is provided, the method comprising the steps of rotating first and second anodes with an anode rotation frequency, generating electromagnetic radiation by one of the first and second anode, switching the generation of the electromagnetic radiation between the first and second anode with a switching frequency, and synchronising the anode rotation frequency with the switching frequency, such that the switching frequency is a half integer multiple of the anode rotation frequency.

Furthermore, according to another exemplary embodiment of the present invention, a computer-readable medium is provided, in which a computer program for examination of an object of interest is stored which, when being executed by a processor, causes the processor to carry out the above-mentioned method steps.

Furthermore, according to another exemplary embodiment of the present invention, a program element for examination of an object of interest is provided, which, when being executed by a processor, causes the processor to carry out the above-mentioned method steps.

The method of examination of the object of interest may be embodied as the computer program, i.e. by software, or may be embodied using one or more special electronic optimization circuits, i.e. in hardware, or the method may be embodied in hybrid form, i.e., by means of software components and hardware components.

The program element according to an embodiment of the invention is preferably loaded into working memories of a data processor. The data processor may thus be equipped to carry out embodiments of the methods of the present invention. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

It may be seen as the gist of an exemplary embodiment of the present invention that an examination apparatus is provided which is adapted for synchronising the anode rotation frequency with the switching frequency in a special way, namely that the time interval between two succeeding illuminations by the electron beam for each point within a focal track is maximized. This may be achieved by synchronising the switching frequency such that it is a half integer multiple of the anode rotation frequency. Thus, the temperature of each anode may be decreased, allowing for an increase of total power of the x-ray source or a decrease of the focal spot size.

These and other aspects of the present invention will become apparent from and elucidated with reference to the embodiments described hereinafter.

Exemplary embodiments of the present invention will be described in the following, with reference to the following drawings.

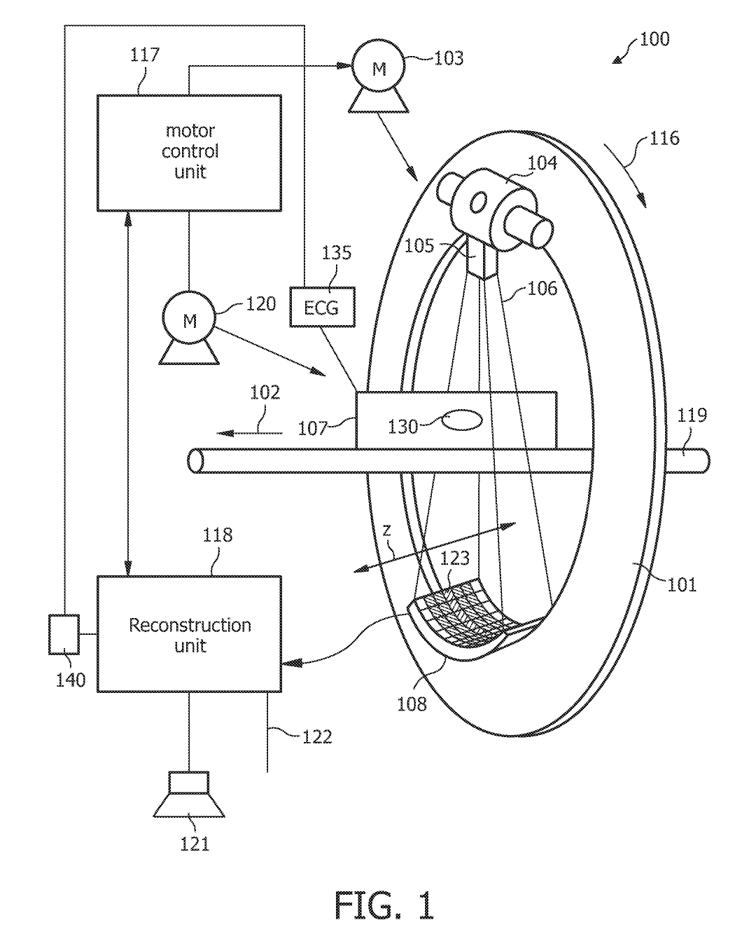

FIG. 1 shows a schematic representation of an examination apparatus according to an exemplary embodiment of the present invention.

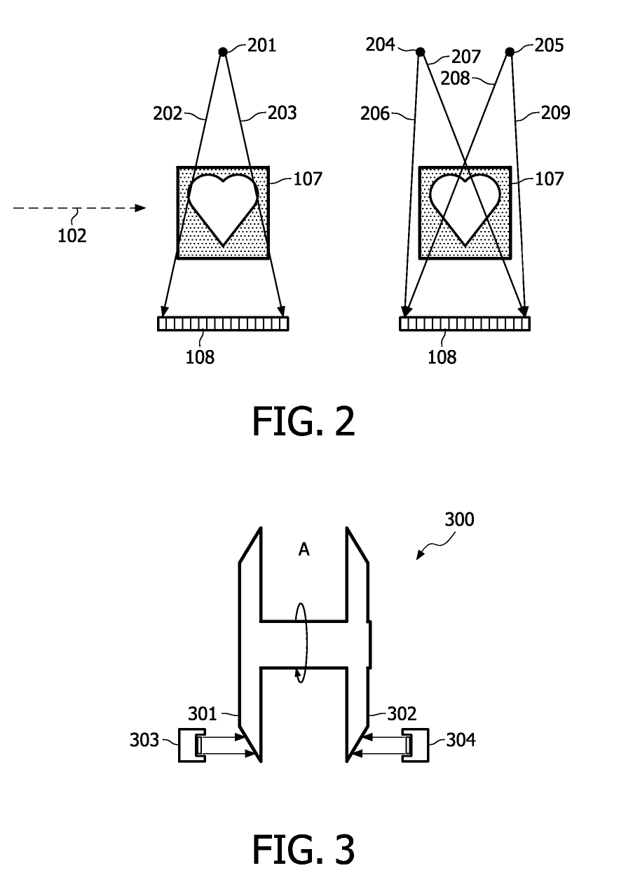

FIG. 2 shows the principle geometry of a single focus tube (left) and of a stereo x-ray tube (right).

FIG. 3 shows a schematic representation of a configuration for a stereo tube according to an exemplary embodiment of the present invention.

FIG. 4 shows the behaviour of the focal spot temperature on the single anode of a conventional x-ray tube.

FIG. 5 shows the behaviour of the focal spot temperature on one of the anodes of a stereo tube.

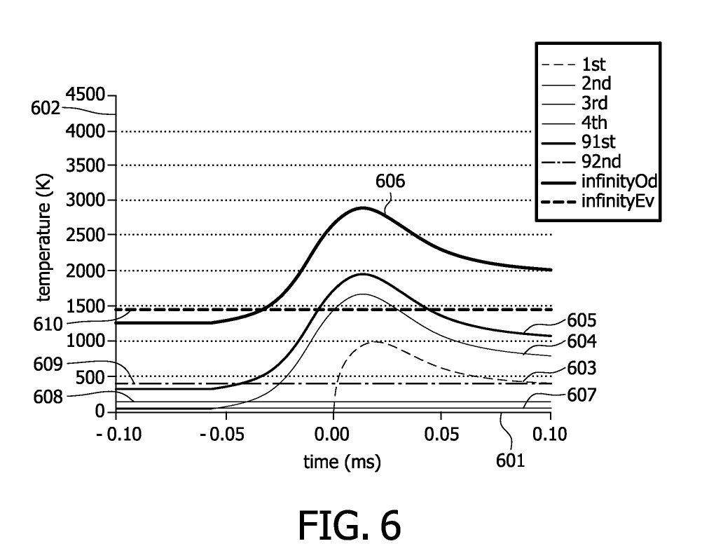

FIG. 6 shows the behaviour of the focal spot temperature on one of the anodes of a stereo tube according to an exemplary embodiment of the present invention.

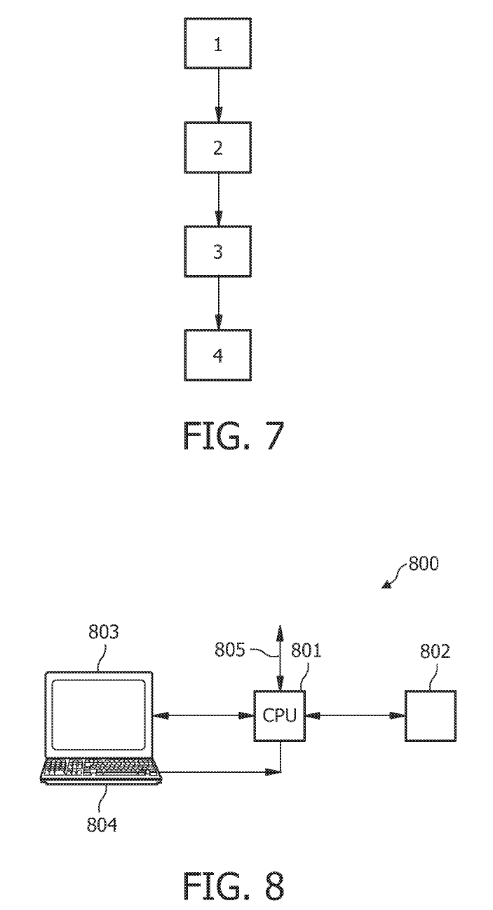

FIG. 7 shows a flow-chart of an exemplary embodiment according to the present invention.

FIG. 8 shows an exemplary embodiment of an image processing device according to the present invention for executing an exemplary embodiment of a method in accordance with the present invention.

The illustration in the drawings is schematically. In different drawings, similar or identical elements are provided with the same reference numerals.

FIG. 1 shows an exemplary embodiment of a computed tomography scanner system according to the present invention. The computed tomography apparatus 100 depicted in FIG. 1 is a cone-beam CT scanner. The CT scanner comprises a gantry 101, which is rotatable around a rotational axis 102. The gantry 101 is driven by means of a motor 103. Reference numeral 104 designates a source of radiation such as an X-ray source, which, according to an aspect of the present invention, emits polychromatic or monochromatic radiation and comprises an X-ray tube.

Reference numeral 105 designates an aperture system which forms the radiation beam emitted from the radiation source 104 to a cone-shaped radiation beam 106. The cone-beam 106 is directed such that it penetrates an object of interest 107 arranged in the centre of the gantry 101, i.e. in an examination region of the CT scanner, and impinges onto the detector 108. As may be taken from FIG. 1, the detector 108 is arranged on the gantry 101 opposite to the source of radiation 104, such that the surface of the detector 108 is covered by the cone-beam 106. The detector 108 depicted in FIG. 1 comprises a plurality of detector elements 123 each capable of detecting X-rays which have been scattered by or passed through the object of interest 107.

During scanning the object of interest 107, the source of radiation 104, the aperture system 105 and the detector 108 are rotated along the gantry 101 in the direction indicated by arrow 116. For rotation of the gantry 101 the source of radiation 104, the aperture system 105 and the detector 108, the motor 103 is connected to a motor control unit 117, which is connected to a reconstruction unit 118 which may comprise the synchronisation unit.

The object of interest 107 may be, for example, a patient which is disposed on an operation table 119. During the scan of, e.g., the heart 130 of the patient 107, the gantry 101 rotates around the patient 107 and the focal spot moves along a circular or other trajectory (e.g. a saddle trajectory). Therefore, a circular scan is performed without displacement of the operation table 119 parallel to the rotational axis 102.

It should be noted however, that the examination apparatus 100 may as well be adapted for performing helical scans (e.g. by moving the table 119).

Moreover, an electrocardiogram device 135 may be provided which measures an electrocardiogram of the heart 130 of the patient 107 while X-rays attenuated by passing the heart 130 are detected by detector 108. The data related to the measured electrocardiogram are then transmitted to the reconstruction unit 118.

The detector 108 is connected to the reconstruction unit 118. The reconstruction unit 118 receives the detection result, i.e. the read-outs from the detector elements 123 of the detector 108 and determines a scanning result on the basis of these read-outs. Furthermore, the reconstruction unit 118 communicates with the motor control unit 117 in order to coordinate the movement of the gantry 101 with motors 103 and 120 with the operation table 119.

The reconstruction unit 118 may be adapted for reconstructing an image from read-outs of the detector 108. A reconstructed image generated by the reconstruction unit 118 may be output to a display (not shown in FIG. 1) via an interface 122.

The reconstruction unit 118 may be realized by a data processor to process read-outs from the detector elements 123 of the detector 108.

The measured data, namely the cardiac computer tomography data and the electrocardiogram data are processed by the reconstruction unit 118 which may be further controlled via a graphical user-interface 140.

It should be noted, however, that the present invention is not limited to this specific data acquisition and reconstruction.

FIG. 2 shows the principle of the stereo x-ray tube for cardiac CT. On the left side, the conventional (single focal spot) geometry is depicted, on the right side the corresponding stereo focus geometry is depicted.

In case of the single focal spot geometry, a focal spot 201 emits a beam of electromagnetic radiation towards the object of interest 107. The beam is detected by detector 108. Here, the detectable size of the beam is limited by the detector size corresponding to rays 202, 203. Reference numeral 102 symbolizes the scanner rotation axis. In the depicted case, not the whole heart can be imaged with a circular scan.

In case of the stereo focus geometry depicted on the right side, two focal spots 204, 205 exist, each emitting electromagnetic radiation towards the object of interest 107, which is then detected by the detector 108. Again, the detectable radiation beams are limited by the outer rays 206, 207 for focal spot 204 and the outer rays 208, 209 for focal spot 205.

While a single focal spot may not be sufficient to cover the complete object of interest (which may be the heart of a patient) 107 during one single circular scan, the dual focus geometry may be able to cover the object of interest 107 completely for the same number of slices of the detector.

It should be noted that circular scan means that there is no patient movement in z-direction, in contrast to a helical scan. The distance of the focal spots depends on the specific geometrical properties of the CT scanner in use, especially the detector width, the focal spot to detector distance and the size of the object under investigation. For a typical CT scanner geometry a field of view (FOV) of 120 mm for a cardiac scan is needed. This may be achieved by using a focal spot distance of approximately 90 mm and a cone-beam detector with 128 slices.

However, other geometries may be implemented depending on the specific circumstances.

FIG. 3 shows a configuration for a stereo tube 300 with two rotating anode disks 301, 302 and two cathodes 303, 304. Such a stereo tube with two rotating anode disks 301, 302 may be used for realising the two foci depicted in FIG. 2.

The method according to an aspect of the present invention for operating a stereo tube, thereby leading to a significant reduction of the focal spot temperature, even at short times (i.e. during the scan), is described in the following in greater detail.

FIG. 4 shows a model calculation of the behaviour of the focal spot temperature on the single anode of a conventional x-ray tube within a short time interval, when the electron beam passes a given fixed point on the anode the first time 403, the second, the third and forth time 404, the 91st time 405 and after an infinite number of times 406.

The horizontal axis 401 depicts the time in milliseconds (ranging from −0.10 ms to 0.10 ms) and the vertical axis 402 depicts the temperature, ranging from 0 (i.e. room temperature) to 4500 degrees above room temperature.

FIG. 5 shows the behaviour of the focal spot temperature on one of the anodes of a stereo tube within a short time interval, when the electron beam passes a given fixed point on the anode the first time 503, the second, third and forth time 504, the 91st time 505 and after an infinite number of times 506. Again, 0 temperature of the vertical axis 502 corresponds to room temperature. The horizontal axis 501 depicts the time in ms, reaching from −0.1 to 0.1 ms.

The power switching frequency was chosen as an integer multiple (s=10) of the anode rotation frequency.

FIG. 5 shows the focal spot temperature for essentially the same parameter set as in FIG. 4, except that the power oscillates with 1800 Hz, which is ten times the anode rotation frequency. Since here the anode switching frequency is an integer multiple of the anode rotation frequency rather than a half integer multiple, there is only a little effect of the power switching after short times. A reason for this small effect is that the maximum spot temperature after 90 revolutions (0.5 s) is almost unchanged compared to the reference case of one anode. However, after long times, the effect of the power sharing between the two anodes becomes visible.

FIG. 6 shows the behaviour of the focal spot temperature of a fixed point on one of the anodes of a stereo tube within a short time interval, when the anode rotates for the first time 603, the second time 607, the third time 604, the forth time 608, the 91st time 605, the 92nd time 609, after an infinite odd number of times 606 and after an infinite even number of times 610.

In case of s=integer, some points on the focal track of the beam of one of the anodes are hit by the electron beam every revolution of the anode. Other points a never hit. In case of s=half integer, the point on the focal track is only hit by the beam during every second revolution of the anode (i.e. the first, third, etc. revolution of the anode), and not during the second, fourth, etc. revolution. Therefore, the thermal power from the beam is distributed over the anode more homogeneously.

The parameters relating to FIG. 6 are the same parameter as in the reference case shown in FIG. 4. The power oscillation frequency is 1710 Hz (corresponding to 9.5 times the anode rotation frequency). The horizontal axis 601 depicts the time in ms and the vertical axis 602 depicts the temperature, wherein 0 temperature again corresponds to room temperature.

Due to the half integer value of s, a fixed point in the focal path is illuminated only every second revolution. This may have a strong effect on the temperature behaviour already after short times, since in this case the effective focal path length is doubled compared to the case with just a single anode. However, even though the focal path length is doubled, the temperature reduction may be less than a factor of 2. In the given example the reduction is after 0.5 s about 20% and increases with time to about 35% after a large number of revolutions. Clearly, this 20% saving in temperature may be used to increase the energy density within the focal spot by 20%, either by increasing the total power or by decreasing the focal spot size. Thus, maximum x-ray power output may be achieved, if the switching frequency is chosen to be a half integer multiple of the anode rotation frequency.

It should be noted, that the inventive concept may be extended to an x-ray tube with multiple anodes in general. For n anodes for example, let t_switch be the time where the beam stays on one anode. If the anodes are illuminated in sequence, t_switch and the rotation time t_anode of the anodes should fulfil the following synchronisation condition: t_anode/t_switch=m*n−1, with, for example, m=1; 2; 3; 4; . . . (m must be integer).

By this method the effective focal path length is n times the focal path length on one of the anodes and thus the possible power increase of the “m-anode-tube” compared to the “one-anode-tube” may be maximized.

FIG. 7 shows a flow-chart of an exemplary method according to the present invention for examining an object of interest and, of course, for synchronising an anode rotation frequency with a switching frequency.

The method starts with step 1, in which the first and second anodes are rotated with an anode rotation frequency. Then, in step 2, electromagnetic radiation is generated by one of the first and second anodes. After that, in step 3, the generation of the electromagnetic radiation is switched from the first (or second) anode to the second (or first) anode. Then, in step 4, electromagnetic radiation is generated by the other one of the first and second anode, followed by a back switching to the anode of step 2. The anode rotation frequency and the switching frequency are synchronised such that the switching frequency is a half integer multiple of the anode rotation frequency.

FIG. 8 shows an exemplary embodiment of a data processing device 800 according to the present invention for executing an exemplary embodiment of a method in accordance with the present invention.

The data processing device 800 depicted in FIG. 8 comprises a central processing unit (CPU) or image processor 801 connected to a memory 802 for storing an image depicting an object of interest, such as the heart of a patient or an item of baggage. The central processing unit 802 may comprise a synchronisation unit (not depicted in FIG. 8) according to an aspect of the present invention.

The data processor 801 may be connected to a plurality of input/output network or diagnosis devices, such as a computer tomography scanner. The data processor 801 may furthermore be connected to a display device 803, for example, a computer monitor, for displaying information or an image computed or adapted in the data processor 801. An operator or user may interact with the data processor 801 via a keyboard 804 and/or other input or output devices, which are not depicted in FIG. 8.

Furthermore, via the bus system 805, it may also be possible to connect the image processing and control processor 801 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

Exemplary embodiments of the invention may be sold as a software option to CT scanner console, imaging workstations or PACS workstations.

The present invention may be applied to stereo rotating tubes. This type of tube may be particularly useful for axial cone-beam CT with a large cone angle, since it enables a significant reduction of the cone-beam artefacts and provides a larger field of view as compared to a single focus tube.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Examination apparatus for examination of an object of interest (107), the examination apparatus (100) comprising:
a source (104) having a first anode (301) and a second anode (302) adapted for generating electromagnetic radiation;
a synchronisation unit (118);
wherein the first and second anodes are adapted as rotating anodes which rotate with an anode rotation frequency;
wherein generation of the electromagnetic radiation is switched between the first and second anode with a switching frequency;
wherein the synchronisation unit (118) is adapted for synchronising the anode rotation frequency with the switching frequency;
wherein the synchronisation corresponds to t_anode/t_switch=m*n−1;
wherein t_anode is 1/(anode frequency);
wherein t_switch is the time an electron beam stays on the first anode;
wherein n is the number of anodes; and
wherein m is an integer.

2. The examination apparatus of claim 1,
wherein the source (104) is adapted as a stereo rotating anode x-ray tube.

3. The examination apparatus of claim 1,
wherein a fixed point on a focal path of the first anode or the second anode is illuminated only every second revolution of the anode.

4. The examination apparatus of claim 1,
wherein the synchronisation unit (118) is adapted for synchronising the anode rotation frequency with the switching frequency, such that the switching frequency is a half integer multiple of the anode rotation frequency.

5. The examination apparatus of claim 1, configured as one of the group consisting of a computer tomography apparatus, and a coherent scatter computed tomography apparatus

6. The examination apparatus of claim 1, further comprising a collimator (105) and a detector unit (108);
wherein the collimator (105) is arranged between the electromagnetic radiation source (104) and the detector unit (108);
wherein the collimator (105) is adapted for collimating an electromagnetic radiation beam emitted by the electromagnetic radiation source (104) to form an axial cone-beam or a fan-beam.

7. The examination apparatus of claim 1, configured as one of the group consisting of a material testing apparatus, a medical application apparatus and a micro CT system.

8. A synchronisation unit (118) for an examination apparatus,
wherein the synchronisation unit (118) is adapted for being connected to a source (104) having a first anode (301) and a second anode (302) for generating electromagnetic radiation;
wherein the first and second anodes are adapted as rotating anodes which rotate with an anode rotation frequency;
wherein generation of the electromagnetic radiation is switched between the first and second anode with a switching frequency; and
wherein the synchronisation unit (118) is adapted for synchronising the anode rotation frequency with the switching frequency, such that the switching frequency is a half integer multiple of the anode rotation frequency.

9. The synchronisation unit (118) of claim 8, wherein the source (104) is adapted as a stereo x-ray tube.

10. A method of examination of an object of interest with an examination apparatus, method comprising the steps of:
rotating first and second anodes with an anode rotation frequency;
generating electromagnetic radiation by one of the first and second anode;
switching the generation of the electromagnetic radiation between the first and second anode with a switching frequency; and
synchronising the anode rotation frequency with the switching frequency, such that the switching frequency is a half integer multiple of the anode rotation frequency.

11. A computer-readable medium (702), in which a computer program for examination of an object of interest is stored which, when executed by a processor (701), causes the processor to carry out the steps of:
rotating first and second anodes with an anode rotation frequency;
generating electromagnetic radiation by one of the first and second anode;
switching the generation of the electromagnetic radiation between the first and second anode with a switching frequency;
synchronising the anode rotation frequency with the switching frequency, such that the switching frequency is a half integer multiple of the anode rotation frequency.

12. A program element for examination of an object of interest, which, when being executed by a processor (701), causes the processor to carry out the steps of:
rotating first and second anodes with an anode rotation frequency;
generating electromagnetic radiation by one of the first and second anode;
switching the generation of the electromagnetic radiation between the first and second anode with a switching frequency;
synchronising the anode rotation frequency with the switching frequency, such that the switching frequency is a half integer multiple of the anode rotation frequency.
